(19) United States
(12) Patent Application Publication
(10) Pub. No.: US 2008/0225258 A1
(43) Pub. Date: Sep. 18, 2008

(54) EUV illumination system having a folding geometry

(75) Inventors: Wolfgang Singer, Aalen (DE); Martin Antoni, Aalen (DE); Johannes Wangler, Koenigsbronn (DE)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Carl Zeiss SMT AG, Oberkochen (DE)

(21) Appl. No.: 12/072,592

(22) Filed: Feb. 27, 2008

Related U.S. Application Data
(62) Division of application No. 10/876,898, filed on Jun. 25, 2004, now abandoned.
Application No. 10/876,898 is a continuation-in-part of application No. 10/055,608, filed on Jan. 23, 2002, now Pat. No. 6,964,485.
Application No. 10/055,608 is a continuation-in-part of application No. 10/150,650, filed on May 17, 2002, now Pat. No. 7,006,595.
Application No. 10/150,650 is a continuation-in-part of application No. 09/679,718, filed on Sep. 29, 2000, now Pat. No. 6,438,199.
Application No. 09/679,718 is a continuation-in-part of application No. 09/305,017, filed on May 4, 1999, now Pat. No. 6,198,793.

(30) Foreign Application Priority Data
May 5, 1998 (DE) 198 19 898
Feb. 2, 1999 (DE) 199 03 807
Feb. 8, 1999 (DE) 299 02 108
Jul. 28, 2000 (EP) PCT/EP00/07258
Jan. 23, 2001 (DE) 101 02 934
Jun. 6, 2001 (DE) 101 27 298
Aug. 10, 2001 (DE) 101 38 313
Jun. 27, 2003 (DE) 103 29 141

(51) Int. Cl. G03B 27/54

(52) U.S. Cl. 355/67

(57) ABSTRACT

There is provided an illumination system. The illumination system includes a source of light having a wavelength of less than or equal to about 193 nm, a first facet, a second facet, and a reflective element. The light is incident on the first facet via a first path, propagates from the first facet to the second facet via a second path, and propagates from the second facet to the reflective element via a third path. The second path and the third path are in substantially opposite directions from one another and substantially parallel to each other.

### BACKGROUND OF THE INVENTION

1. Field of the Invention

The present invention relates to an illumination system, especially for lithography that employs light with wavelengths less than or equal to about 193 nanometers (nm). More specifically, the illumination system includes at least one light source, a collector and a double-facetted optical component, and is associated with an EUV projection illumination system.

2. Description of the Related Art

In order to enable the further reduction of the structural widths for electronic components, especially in the submicron range, it is necessary to reduce the wavelength of the light used for microlithography. For this purpose, light with wavelengths ≦193 nm can be used. Lithography using soft X-rays, i.e., so-called EUV lithography, is particularly well-suited for this use.

EUV lithography is one of the most promising future lithography techniques. Wavelengths currently used in EUV lithography lie in the range of 11 to 14 nm. For example, a wavelength of 13.5 nm is often used. In an EUV projection illumination system, image quality is influenced by an illumination system and a projection lens. The illumination system is intended to provide a uniform illumination of a field plane in which a structure-bearing mask, a so-called reticle, is situated. The projection lens projects the field plane to an image plane, a so-called wafer plane, in which a light-sensitive object is arranged. Projection exposure systems for EUV lithography are equipped with reflective optical elements. The shape of a field of an EUV projection exposure system is typically that of a ring field with a high aspect ratio of 2 mm (width)×22 to 26 mm (arc length). The projection systems are usually operated in a scanning mode, with the reticle being moved in the field plane and the light-sensitive object (usually a wafer) with a suitable photoresist being moved in the image plane in synchronicity relative to each other.

Reference is hereby made to the following publications concerning EUV projection exposure systems:
(a) W. Ulrich, S. Beiersdorfer, H. J. Mann, “Trends in Optical Design of Projection Lenses for UV and EUV lithography” in Soft-X-Ray and EUV Imaging Systems, W. M. Kaiser, R. H. Stulen (Publishers), Proceedings of SPIE, Vol. 4146 (2000), pages 13 through 24; and
(b) M. Antoni, W. Singer, J. Schultz, J. Wangler, I Escudero-Sanz, B. Kruizing a, “Illumination Optics Design for EUV Lithography”, in Soft-X-Ray and EUV Imaging Systems, W. M. Kaiser, R. H. Stulen (Publishers), Proceedings of SPIE, Vol. 4146 (2000), pages 25 through 34.

The scope of disclosure of these publications is fully incorporated into the present application.

Illumination systems include components for collecting light from a light source, spectral filtering, forming an illuminated field in a field plane and for forming an advantageous filing of an exit pupil of the illumination system. A disadvantage of current state-of-the art illumination systems is that such components require a large amount of space.

### SUMMARY OF THE INVENTION

An object of the present invention is to provide an EUV illumination system that illuminates a field plane and an exit pupil of the illumination system in which wavelengths of light that illuminate the field plane contain only wavelengths in a particular range, for example in a range of about 11 nm to about 14 nm, and substantially no light of other wavelengths, for example wavelengths above 100 nm. That is, the light in the field plane is spectrally pure. Furthermore the illumination system should be of a compact design. Also, an optical component that is susceptible to soiling should be easily cleanable.

An illumination system that meets the requirements of EUV illumination includes:
(a) light source;
(b) a collector for collecting light emitted by the light source;
(c) a first optical component that includes a first optical element with a first raster element and a second optical element with a second raster element.

The first optical component is also denoted as double-facetted optical component. U.S. Pat. No. 6,198,793 B1 discloses, an exemplary embodiment of an illumination system having a double-facetted optical component. The full disclosure of U.S. Pat. No. 6,198,793 B1 is herein incorporated by reference.

The illumination system also includes a second optical situated in a light path from the light source to a plane downstream of the first optical component. When employed in an EUV illumination system, a patterned mask is situated in the plane.

The light travels along a beam path, i.e., a first beam path, from either the light source or an intermediate image of the light source, to the first optical element. The light travels along a second beam path from the first optical element to the second optical element, and along a third beam path from the second optical element to a first reflective optical element.

An advantageous folding geometry for the EUV illumination system includes folding the beam path in a region of the double-facetted element. The double-facetted element receives the light via the first beam path, and guides the light to proceed along the second beam path. A plurality of secondary light sources is formed in the second beam path. The second optical element is situated close to the secondary light sources. The first reflective optical element is situated in the third beam path, and is positioned substantially in a plane of the first optical element and directly adjacent to the first raster element. The first reflective optical element reflects the light coming from the second optical element to further optical elements, which, like the first reflective optical element, are a part of a second optical component. The second optical component forms an illuminated field in a field plane. The EUV illumination system may also include a second reflective optical element and a grazing-incidence mirror.

In order to achieve an especially compact design, the first and second beam path are in opposite directions from one another and extend substantially parallel with respect to each other. This means that an averaged chief ray over all light beams of the first beam path and an averaged chief ray over all light beams of the second beam path have opposite directions and extend in a parallel direction with respect to each other, except for a slight deviation. Also the second and the third beam path are in opposite directions from one another and extend substantially parallel with respect to each other. This means that the averaged chief ray over all light beams of the second beam path and the an averaged chief ray over all light beams of the third beam path have opposite directions and extend in a parallel direction with respect to each other, except for a slight deviation. Slight deviations from the extension in a parallel direction are angular deviations of less than or equal to about 12°, with an angular deviation less than or equal to about 5° being preferable because this is advantageous both for decreasing the overall size of the illumination system, as well as for an advantageous arrangement of the first and second raster elements.

An arrangement of the first reflective optical element in the central region of the first optical element is preferably provided. This is possible in an advantageous manner when this region is not illuminated by the first beam path between the light source, or an intermediate image of the light source, and the first optical element. This is especially the case when grazing-incidence mirrors are used as collectors for collecting the light from the light source, especially in the form of a nested collector that below a certain aperture does not make any contribution of light for the illumination system. A shaded region in the central region of the first optical element can also be provided by the use of central diaphragms or by the combination of central diaphragms with nested collectors.

As a result, a substantially annular illumination is thus obtained in the region of the first optical element, so that the first raster elements are arranged on the first optical element only in this illuminated region. The center of the first optical element does not include any first raster elements, and instead, the first reflective optical element is attached to the center of the first optical element for the reflection of the light coming from the third beam path.

In an advantageous embodiment of the invention, a combination of a grating spectral filter and a diaphragm device for spectral filtering in the illumination system is used in the light path from the light source to the field plane between the collector and the first optical element. Typically, an image of the light source is formed in the area that the diaphragm device is situated, with various diffraction orders fanning out in a spatial manner. By using a collector that collects light only above a certain minimum aperture and is advantageously equipped with a central diaphragm, a shadowing effect occurs here on the first optical element. Positioning the first reflective optical element in the area in or near which the central shadowing occurs, allows for a folding of the second and third beam paths, and thus, a reduction in the size of the illumination system.

In a further aspect of the invention it is possible to produce a further intermediate image of the light source in the region of the second optical element. In an preferred embodiment of the invention, the beam path is guided through a passage or diaphragm of the second optical element. The light beams that are guided through the second optical element start from an image of the light source and propagate towards the first optical element. Preferably, the passage is provided in the central area of the second optical element. As a result, this embodiment leads to a further folding in the beam path in the area in which the double-facetted element is situated, with the first beam path being guided in an opposite manner relative to the second beam path, and substantially in a parallel manner. Furthermore, the second beam path and the third beam path are guided in a similarly opposite and a substantially parallel manner. The beam paths are defined by the chief rays that extend substantially parallel to one another and only show slight angular deviations from one another. In a preferable embodiment, such angular deviations of the chief rays of the different beam paths are less than 5°.

Further variants are possible. In that variants in the place of the first and second intermediate a light source can be situated. Alternatively only one first intermediate image of the light source is formed and the first intermediate image of the light source comes to lie in the region of the passage in the second optical element.

The folding of the beam path in the region of the double-facetted element allows for an especially compact design of the illumination system. In addition to the compact design, as a result of the folding geometry, it is possible to use additional mechanical and electronic components and especially cleaning chambers in an advantageous positioning in the illumination system. The images of the light source formed for this advantageous folding geometry can be used additionally by using grating spectral filters and diaphragms for spectral filtering of the illuminating light.

### BRIEF DESCRIPTION OF THE DRAWINGS

The invention is now explained in closer detail by way of examples by reference to the enclosed drawings, wherein:

FIG. 1 shows an EUV illumination system, with the first reflective optical element of the second optical component being situated in the region of the central shadowing of the first optical element with raster elements;

FIG. 2 shows a first optical element with first raster elements and central shadowing;

FIG. 3 shows an illumination system with the first reflective optical element of the second optical component positioned in the central shadowing of the first optical element with first raster elements as well as a first intermediate image of the light source in the plane of the second optical element with second raster elements and a beam path passing through the second optical element;

FIG. 4 shows an illumination system with an analog beam path as in FIG. 3 and an additional normal incidence concave mirror after the first intermediate image of the light source and the formation of a second intermediate image of the light source in the region of the second optical element with second raster elements;

FIG. 5 shows an illumination system with an analogous beam path as in FIG. 4 and a cleaning chamber between the first intermediate image and the second intermediate image of the light source;

FIG. 6 shows an arrangement of the first reflective optical element in direct vicinity to the first optical element with first raster elements and opposite of the intermediate image of the light source;

FIG. 7 shows an arrangement of the first reflective optical element in direct vicinity of the first optical element with first raster elements and positioned on the side of the intermediate image of the light source;

FIG. 8 shows an EUV lithography system for microlithography.

### DESCRIPTION OF THE INVENTION

FIG. 8 shows an arrangement of an EUV lithography system for microlithography. A projection exposure system 1000 includes an illumination system 1010 and a projection optical system, i.e., a projection objective 126. A reticle or mask 11 is positioned in a field plane 13 and projected by projection objective 126 onto an image plane 130 that contains a wafer 106 that includes a light-sensitive material. Projection exposure system 1000 is arranged as a scanning system so that mask 11 and wafer 106 are moved in synchronicity in order to produce an illumination or exposure.

Illumination system 1010 includes a light source 1 for wavelengths of less than or equal to about 193 nm. Light source 1 may be provided, for example, by an ArF excimer laser with a light wavelength of λ=193 nm, or by a F₂ laser having a wavelength of λ=157 nm. A preferred embodiment of light source 1 is a laser plasma X-ray source having a wavelength of λ=5 to 20 nm. As an alternative, however, it is also possible to use a synchrotron source with wavelengths λ=10 nm to 15 nm.

Radiation, i.e., light, emitted from light source 1 is collected by a collector unit 9 and produces a converging light beam. Collector unit 9 acts in a collimating manner and forms an intermediate image Z of light source 1. FIG. 8 represents collector unit 9 as a nested collector composed of several collector shells and configured as a Wolter mirror system with two reflections. Such a mirror system may be configured, for example, as a combination of hyperboloid and ellipsoid mirrors and as described, for example, in “Annalen der Physik” (Annals of Physics) 10, 94 to 114, 1952, the scope of disclosure of which is being fully incorporated herein.

Generally, a spectrally pure illumination of field plane 13 is desired. However, it is often not possible, or is impractical, to implement light source 1 with a narrowband light source or a laser because the light yield from light source 1 would be inadequate. Instead, a certain spectral scattering of the light is allowed and additional elements with a filtering effect are used in the illumination system. For example, a grating element 200 is situated between light source 1 and intermediate image Z, and a diaphragm 202 is situated after grating element 200 in a region in which intermediate image Z is situated. Grating element 200 and diaphragm 202 co-operate to provide spectral filtering of the light. More specifically, grating element 200 provides spectral separation by diffracting light, and diaphragm 202 has an aperture through which a desired diffracted portion of the light is allowed to pass, while non-desired diffracted portions of the light are blocked by diaphragm 202. For example, light of a 0^{th} diffraction order with a wavelength above 100 nm is separated out, i.e., light with a wavelength greater than 100 nm is be prevented from propagating downstream of a diaphragm 202. Instead of the diaphragm 202 being used alone, a plurality of diaphragms (not shown) could be used. The plurality of diaphragms can be arranged in a staggered configuration.

Furthermore, diaphragm 202, or the plurality of diaphragms, can be cooled by a cooling device (not shown).

A preferred spectral filtering is achieved by using at least one additional mirror with a multi-layer system in addition to grating element 200. Such a mirror can be part of a collector system that includes a nested collector and the aforementioned additional multiplayer-mirror (not shown). By adding such a mirror with a multi-layer system it is possible to separate wavelength of 13.5 nm and wavelengths above 100 nm from other wavelengths that are emitted by light source 1. By combining the mirror with a multilayer-system with grating element 200 an illumination is obtained which is substantially pure from a spectral viewpoint.

Since collector unit 9 receives light from light source 1 and produces a converging beam, and since grating element 200 is situated downstream of collector unit 9 in a path of the converging beam, the optical effect of grating element 200 must be taken into account. Preferably, grating element 200 is configured as several individual gratings. The individual gratings are applied to a curved supporting surface. For example, the individual gratings can be arranged as blazed gratings having reflection layers made of ruthenium, palladium or rhodium, with a high efficiency η(−1) for reflectivity of typical wavelengths λ=13.5 nm. The combination of grating element 200 and diaphragm 202 improve the quality of the illumination and reduce the thermal load of components of illumination system 1010, components of projection objective 126, and mask 11, as compared to an illumination system that does not include grating 200 and diaphragm 202.

Illumination system 1010 includes a double-facetted element 1015 that, in turn, includes a field facet mirror 3 and a pupil facet mirror 5. Field facet mirror 3 is also referred to herein as a first optical element and includes a plurality of first raster elements (not shown in FIG. 8). Pupil facet mirror 5 is also referred to herein as a second optical element and includes a plurality of second raster elements (not shown in FIG. 8). Field facet mirror 3 and the pupil facet mirror 5 can each be provided with a cooling device (not shown) to reduce thermal load.

A raster element, also known as a honeycomb, is an element of surface that receives a beam of light, wherein the raster element directs a portion of the beam of light to another surface. In a typical configuration, the surface contains a plurality of raster elements that collectively receive the beam of light, wherein each of the individual raster elements reflects directs a respective portion of the beam of light. Raster elements may be either reflective or transmissive. The raster elements of field facet mirror 3 and of pupil facet mirror 5 are reflective.

Each of the raster elements of field facet mirror 3 directs light to a corresponding one of the raster elements of pupil facet mirror 5. Thus, each of the raster elements of field facet mirror 3 is assigned to a corresponding one of the raster elements of pupil facet mirror 5.

Field facet mirror 3 and pupil facet mirrors 5 are used for illuminating a field in field plane 13 and for configuring the illumination in an exit pupil 252 of illumination system 1010. Each raster element of field facet mirror 3 forms an image of light source 1. Thus, the plurality of raster elements of field facet mirror 3 form a plurality of so-called secondary light sources 1017. As is shown in FIG. 8, the beam from intermediate image Z widens, and is thereafter focused into the secondary light sources 1017 in the region of pupil facet mirror 5. Focusing into secondary light sources 1017 can be achieved, for example, by a concave configuration of the mirror support of the plurality of raster elements of field facet mirror 3 and by a respective tilting of the plurality of raster elements of field facet mirror 3. Secondary light sources 1017 are imaged as tertiary light sources into exit pupil 252 by an optical component 1020. Optical component 1020 includes a reflective element 19, a reflective element 21, and a grazing incidence mirror 23.

Each of the plurality of raster elements of field facet mirror 3 is imaged into field plane 13 by the plurality of raster elements of pupil facet mirror 5, in co-operation with reflective element 19, reflective element 21, and grazing incidence mirror 23. Light reflected by the plurality of raster elements of field facet mirror 3 is manipulated by grazing incidence mirror 23 to form a ring field segment in field plane 13. The images of the plurality of raster elements of field facet mirror 3 substantially overlap in field plane 13, and illuminate mask 11. The illumination in field plane 13 is in a form of a ring field segment.

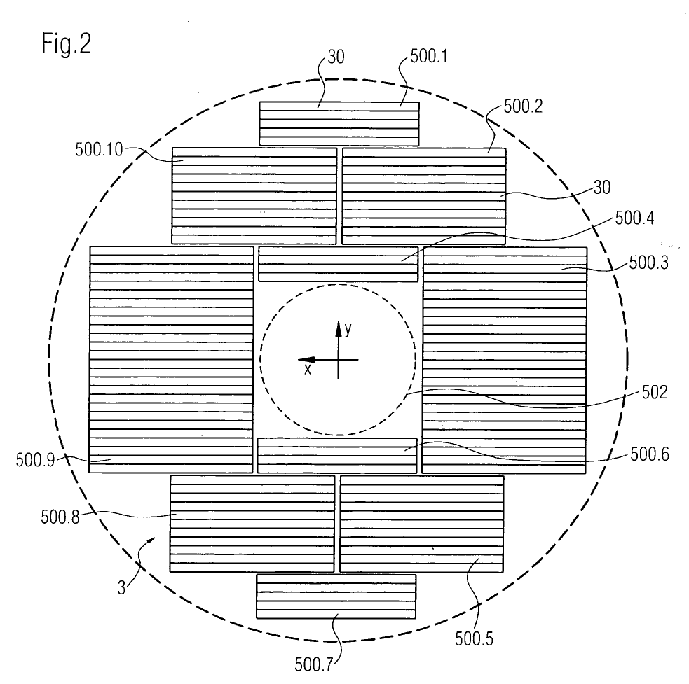

FIG. 2 is an illustration of an exemplary embodiment of field facet mirror 3, and shows the plurality of first raster elements of field facet mirror 3 being represented by reference numeral 30. In the embodiment represented in FIG. 2, first raster elements 30 are rectangular. Recall that grazing incidence mirror 23 manipulates light from first raster elements 30 to form a ring field segment in field plane 13. In an alternative embodiment of field facet mirror 3, first raster elements 30 are arc-shaped facets, and so provide for the ring field shape without manipulation of light by grazing incidence mirror 23. In the alternative embodiment, first raster elements 30 can have a shape corresponding to the ring field shape, e.g., raster elements 30 can be arc-shaped, and in such an alternative embodiment, grazing incidence mirror 23 is not necessary.

Raster elements 30 are organized into several blocks 500.1 to 500.10 situated around a central region 502 that does not include any raster elements 30. With reference to FIG. 8, recall that light propagates from grating element 200 towards field facet mirror 3. Central region 502 is not illuminated by the light that propagates from grating element 200 towards field facet mirror 3. Thus, central region 502 can be designated as a shadowed area or a shaded area.

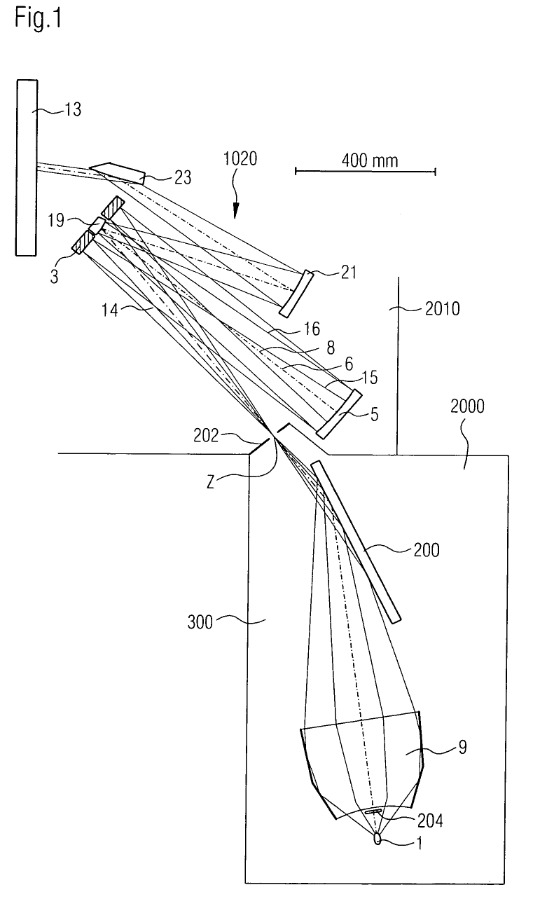

A technique for providing shading for central region 502 is to provide a diaphragm in collector unit 9 that casts a shadow. Referring to FIG. 1, there is shown a central diaphragm 204 in the interior of collector unit 9. Diaphragm 204 blocks light that is scattered in a central region of collector unit 9 and ensures that central region 502 of field facet mirror 3 is shaded. Reflective element 19 is situated in central region 502 of the field facet mirror 3 (see FIG. 1). This provides for the inventive beam path.

Even in the case of collector 9 being a normal-incidence collector, it is possible to create a shaded central region 502 on field facet mirror 3. Generally speaking, a normal-incidence collector is, in a reflective design, a mirror that is situated, for example, downstream of the light source to collect light and focus the light in the direction of the illumination system. The shaded area can then be obtained, for example, by using a diaphragm.

FIG. 8 further shows a chief ray 4 as a connecting line of all optical surfaces of illumination system 1010. Chief ray 4 designates a chief ray of the whole illumination system and is defined as a ray that intersects the field in the field plane in the center (0,0) and furthermore intersects the center (0,0) of the exit pupil in the pupil plane.

A chief ray 6 propagates from field facet mirror 3 to pupil facet mirror 5. A chief ray 8 propagates from pupil facet mirror 5 to reflective element 19. Chief ray 6 and chief ray 8 are inclined towards each other at an angle α₁ of approximately 10°.

Projection objective 126 has an entrance pupil (not shown) that generally coincides with exit pupil 252. Projection objective 126 has six individual mirrors 128.1 through 128.6, although other configurations are possible. FIG. 8 further shows an ideally telecentric illumination of image plane 130. That is, a chief ray of a bundle of rays that commences from a field point in field plane 13 intersects image plane 130 perpendicularly.

FIG. 8 also shows a virtual exit pupil 250 of the illumination system 1010. Virtual exit pupil 250 is situated in a plane that also includes an intersection of an optical axis OA and chief ray 4 that emerges from a central field point (0,0) of a field in field plane 13. Rays from field plane 13 are reflected by mirror 128.1 toward mirror 128.2, and exit pupil 252 lies in or near a plane in which mirror 128.2 is situated.

FIG. 1 shows a first embodiment of the invention having a first beam path 14 from intermediate image Z to field facet mirror 3, a second beam path 15 from field facet mirror 3 to pupil facet mirror 5, and a third beam path 16 from the pupil facet mirror 5 to the first reflective optical element 19. Reflective element 19 is situated in the area of the central shading (FIG. 2, reference 502) of field facet mirror 3. Second beam path 15 and third beam path 16 are in substantially opposite directions. The subsequent beam path corresponds substantially to that of FIG. 8 in which the beam path is guided to field plane 13 via reflective element 21 and grazing-incidence mirror 23, and a field illumination is formed. The embodiment in FIG. 1 therefore shows an illumination system that includes a source of light 1, a field facet mirror 1 having a first facet, a pupil facet mirror 5 having a second facet; and a reflective element 19. Light that is incident on the first facet via a first beam path 14, propagates from the first facet to the second facet via a second beam path 15, and propagates from the second facet to reflective element 19 via a third beam path 16. Second beam path 15 and third beam path 16 are in substantially opposite directions from one another and substantially parallel to each other.

In FIG. 1, chief ray 6 and chief ray 8 are in opposite directions from one another, and are substantially parallel to each other, although they need not to be exactly parallel. They can deviate from one another to such an extent as is permitted by the positioning of reflective element 19 within the central region 502. However, it is preferred that chief rays 6 and 8 be at an angle to one another of not more than 5°.

The inclusion of reflective element 19 in central region 502 allows an especially compact design. An especially simple assignment of the raster elements of field facet mirror 3 to the raster elements of pupil facet mirror 5 is enabled by the substantially parallel guidance of the beams between field facet mirror 3 and pupil facet mirror 5. A further advantage is that light incident on the raster elements of field facet mirror 3 and light incident on the raster elements of pupil facet mirror 5 has a low angle of incidence.

Furthermore, reflectivity losses are reduced. A reduction in overall space is especially advantageous for an EUV illumination system because the EUV-illumination system is typically installed in a vacuum chamber.

The folding geometry in accordance with the invention leads to an especially compact design of the illumination system 1010. The intermediate images Z further allow separating the illumination system 1010 into compartments, thus realizing a modular design of illumination system 1010. For example, referring to FIG. 1, light source 1, collector unit 9, grating element 200, and diaphragm 202 are grouped into a compartment 300 within a module 2000, and double-facetted element 1015 (i.e., field facet mirror 3 and the pupil facet mirror 5), and optical component 1020 (i.e., reflective element 19, reflective element 21, and grazing incidence mirror 23) are arranged in an illumination module 2010. Compartment 300 spatially confines, to compartment 300, debris that may be emitted by light source 1.

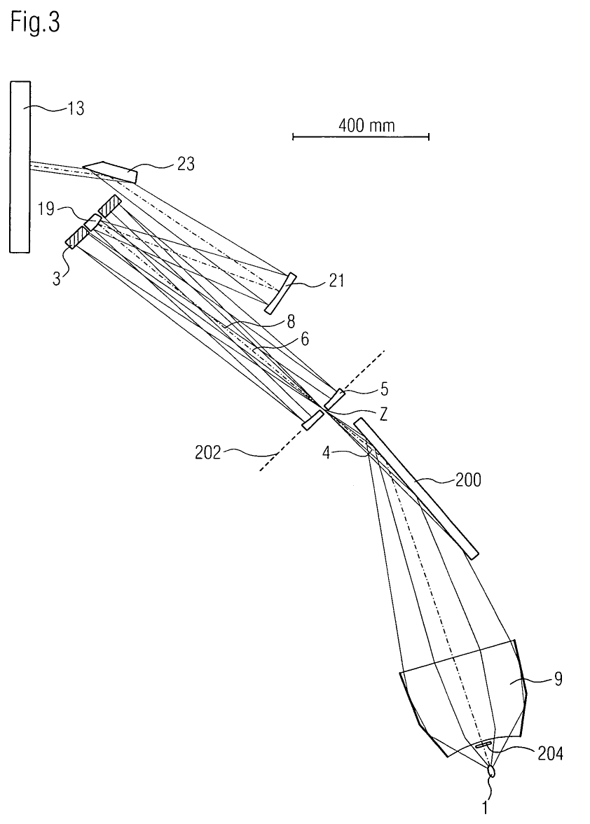

FIG. 3 shows a further embodiment of the inventive idea. In the embodiment shown in FIG. 3, intermediate image Z is projected into a region that is directly adjacent to a rear side of pupil facet mirror 5. The embodiment represented in FIG. 3 also includes components, like those of FIG. 1, for collecting the light of light source 1 and for spectral filtering. For example, FIG. 3 includes collector unit 9, configured as a nested collector with a centrally positioned diaphragm 204, and a spectral grating filter 200 with associated physical diaphragm 202. In contrast with the embodiment of FIG. 1, the embodiment of FIG. 3 forms intermediate image Z on a rear side of pupil facet mirror 5, adjacent to pupil facet mirror 5. Light from intermediate image Z passes through a spatially limited aperture in pupil facet mirror 5 so that chief ray 4 extends through intermediate image Z to field facet mirror 3. Chief ray 6 propagates from field facet mirror 3 to the pupil facet mirror 5. Chief ray 4 and chief ray 6 are in substantially opposite directions from one another, and substantially parallel to one another. Chief ray 8 propagates from pupil facet mirror 5 to reflective element 19. Chief ray 6 and chief ray 8 are also in substantially opposite directions from one another, and also substantially parallel to one another.

In addition to a further reduction of the overall space, where pupil facet mirror 5 has an aperture for first beam path 4, as shown in FIG. 3, pupil facet mirror 5 can serve as a physical diaphragm for filtering undesirable diffraction orders. That is, only a desirable spectral range as reflected by spectral grating 200 is permitted through the aperture in pupil facet mirror 5.

An especial advantage of the embodiment of FIG. 3 with double folding of the beam path is that in this case both the plurality of raster elements of field facet mirror 3 and the plurality of raster elements of pupil facet mirror 5 have smaller incidence angles for beams impinging thereon. Reflection losses within the illumination system are thus lower. Also, if one assigns a light channel for light reflected by a raster element of field facet mirror 3 to a corresponding raster element of pupil facet mirror 5, then such an assignment is subject to fewer restrictions. For example, where the length of a light channel is a distance between a raster element of field facet mirror 3 and its corresponding raster element of pupil facet mirror 5, lengths of different light channels can be made to be approximately equal to one another. Therefore, a variation of linear magnification with which a raster element of field facet mirror 3 is imaged into the field plane is lower assuming that the all raster element of field facet mirror 3 have the same radii of curvature. This means the system can be easily corrected.

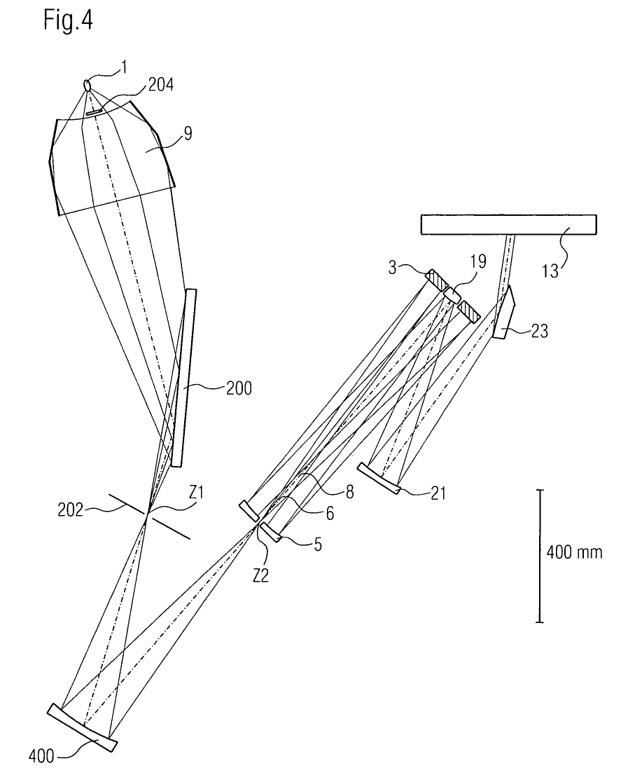

FIG. 4 shows a further embodiment of the inventive idea as shown in FIG. 3 of a further folding of the illumination geometry in the region of the double-facetted element (i.e., field facet mirror 3 and pupil facet mirror 5). A first intermediate image Z1 of light source 1 is formed here in a region of diaphragm 202, so that a spectral filtering can be performed by that diaphragm 202. From intermediate image Z1 the light will reach a second intermediate image Z2 of light source 1 via a normal-incidence concave mirror 400. Normal-incidence concave mirror 400 collimates the light. Intermediate image Z2 is situated at the rear side of, and directly adjacent to, pupil facet mirror 5. Advantageously, a beam path is obtained that is folded twice in itself in a region of the double-facetted element with field facet mirror 3 and pupil facet mirror 5. Furthermore a spectral filtering is provided by grating element 200 in conjunction with diaphragm 202 and normal-incidence concave mirror 400. In this way it is possible on the one hand to reduce the thermal load on the construction of pupil facet mirror 5 and on other hand to achieve a further space-saving and thus advantageous folding of the beam path in the illumination system by using normal-incidence concave mirror 400. Moreover, normal-incidence concave mirror 400 performs a wavelength filtering as a first multi-layer coated mirror, is subjected to a high thermal load and contamination, can be cooled more easily, and can be designed to be movable into a cleaning apparatus for regular cleaning.

The first and last optical surfaces of reflective systems are especially likely to be contaminated because they are situated in direct vicinity of a light source, a mask or a wafer to be exposed. Impurities can be introduced into the optical system from these components. High-energy radiation of the light sources having wavelengths ≦193 nm lead may cause residual oxygen to be converted into ozone. Ozone can attack surfaces of the optical elements (i.e., their coatings) and can destroy them. Additionally, residual gas concentrations such as hydrocarbons in ambient atmosphere can form contaminants on the optical surface, e.g., by crystal formation or layers made of carbon or carbon compounds.

The contamination can depend on the luminous intensity. Sources can be used in EUV lithography which radiate a broadband spectrum. Even after a spectral filtering, e.g., with a grating spectral filter, there is a wide spectrum of high-energy radiation. The radiation load in EUV system is especially high in the first optical component up to the first multi-layer mirror because a broadband radiation of the source that provides many wavelengths, wavelengths other than 13.5 nm for example, is present up to that point, and thus the radiation load is at its maximum. The loss of reflection on the first normal-incidence mirror in an illumination system with an EUV projection exposure system is highest for the reason that this mirror receives the highest power density of the light source, but will only reflect selectively, at 13.5 nm for example, due to the multilayer coating. All other radiation which is emitted by the EUV source will thus be converted into absorption energy.

Carbon and carbon compounds are removed by regular cleaning of the mirrors, e.g., by adding argon and oxygen under an RF plasma. Concerning the cleaning of contaminated lens systems, reference is hereby made to the following publication:

F. Eggenstein, F. Senf, T. Zeschke, W. Gudat, “Cleaning of contaminated XUV optics at Bessy II”, Nuclear Instruments and Methods in Physics Research A 467-468 (2001) p 325-328, the scope of disclosure of which is hereby fully included in the present application.

Such a cleaning of the mirrors is typically recommended at short intervals. The overall times in which machines can be operated are thus reduced by the times in which the mirrors must be cleaned. It may be necessary for example to clean the first normal-incidence mirror in an EUV projection exposure system after only 20 hours of operation. This cleaning may require several hours.

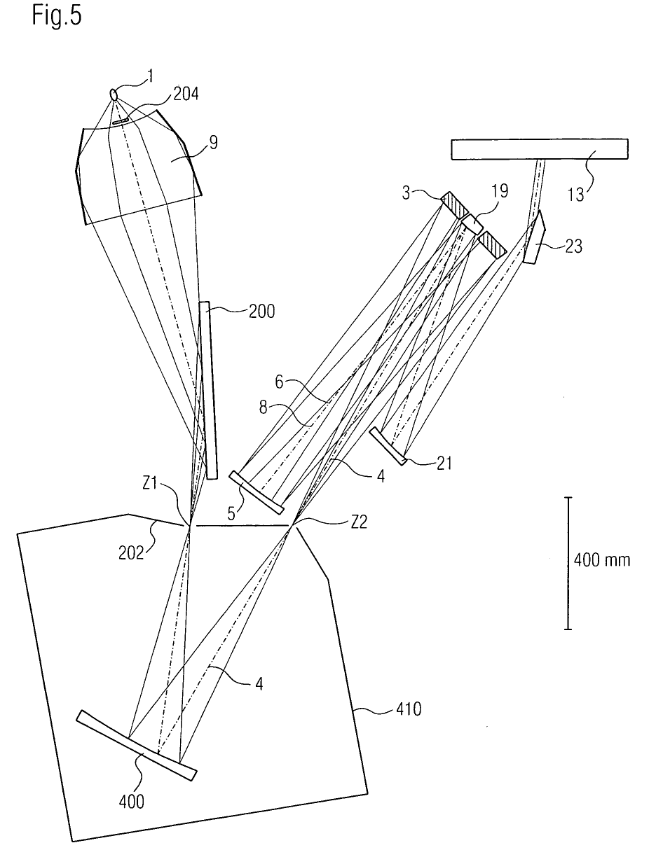

The folding in accordance with the invention allows a favorable accessibility of the first multi-layer mirror and the formation of a compact cleaning chamber 410 as shown in FIG. 5. Cleaning chamber 410 is separated from the other components both spatially and atmospherically, e.g., by vacuum. For cleaning purposes, cleaning chamber 410 may accept a certain gas concentration, preferably an oxygen concentration and/or an argon concentration, or a gas stream, or it may include a cleansing apparatus, for example, a UV light source, an RF antenna for producing a high-frequency plasma, electrodes for applying fields, or a mechanical cleaning device.

An arrangement of the optical components to be cleaned in a separate vacuum chamber, such as cleaning chamber 410, is advantageous because components contained within cleaning chamber 410 can be cleaned continuously and automatically, for example, by adding a certain concentration of oxygen during the operation, and a complete cleaning will only be necessary after longer operation periods. Also, by including specific components within cleaning chamber 410, or within any cleaning chamber, the remaining system (not in the cleaning chamber) is also protected from possibly damaging influences of cleaning.

As is shown in FIG. 4, the beam paths in opposite directions in accordance with the invention lead to an advantageous configuration of the overall space which can be used for forming a cleaning chamber 410. FIG. 4 outlines the progress of the beam after the second intermediate image of the light source Z2. It corresponds to the embodiment which is shown in FIG. 3. In particular, a folding in accordance with the invention is achieved by the opposite direction of the second beam path with chief ray 6 from the field facet mirror 3 to the pupil facet mirror 5 relative to the third beam path with chief ray 8 from the pupil facet mirror 5 to reflective element 19 by positioning reflective element 19 in the region of the central shading of field facet mirror 3. FIG. 4 shows that reflective element 19 can also have a light offset relative to the central point of field facet mirror 3.

FIG. 5 shows a further embodiment of the invention. Although in this case the second intermediate image Z2 of light source 1 is formed adjacent to and preferably in the plane of pupil facet mirror 5, chief ray 4 is not guided through a passage in pupil facet mirror 5. Chief rays 6 and 8 extend substantially parallel in accordance with the invention. Preferably, they are tilted relative to each other by an angle of not more than 5°.

Only the first intermediate image Z1 or second intermediate image Z2 can come to lie in the plane of pupil facet mirror 5, and reflective element 19 can be located adjacently to or even spaced from field facet mirror 3, so that only the first beam path from intermediate image Z1 or Z2 to field facet mirror 3, and the second beam path from field facet mirror 3 to pupil facet mirror 5 extend in opposite directions and substantially parallel with respect to each other.

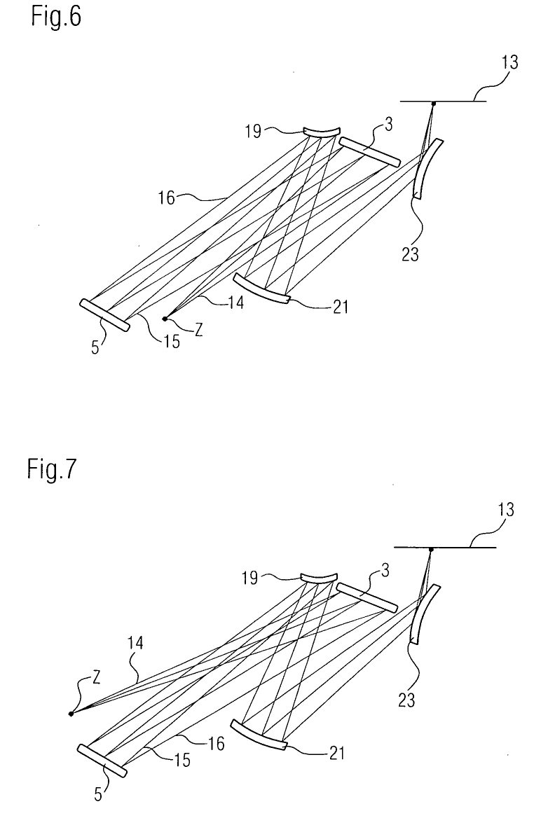

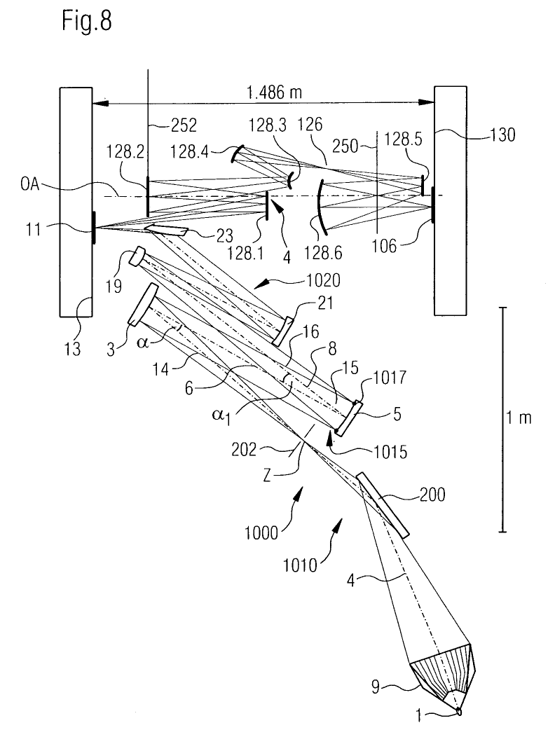

It is further provided in accordance with the invention that reflective element 19 can be positioned outside of the central shadowing of field facet mirror 3. Reflective element 19 is nevertheless situated substantially in the plane of field facet mirror 3 and in a vicinity to the raster elements of field facet mirror 3. Such an arrangement is shown in FIGS. 6 and 7. FIGS. 6 and 7 further show that intermediate image Z, which may be an image of light source 1 or alternatively a second or further intermediate image of light source 1, can be positioned with a slight offset to the center of pupil facet mirror 5, but a vicinity of pupil facet mirror 5. The spacing can preferably be chosen in such a way that the angles of incidence of chief rays 4, 6 and 8 are not more than 6° over all rays on the facet mirrors, i.e., the angles of incidence are reduced, which thus allows achieving a simpler construction capability and higher reflectivity. If the distance between the plane of the field facet plane or the first reflective optical element and the plane of the pupil facet plate or the intermediate image of the source Z is approximately one meter, it follows therefrom that the distance of the center points of the mutually adjacently situated optical elements is not more than approximately 100 mm, i.e., the center point of the pupil facet mirror 5 is not farther away than approximately 100 mm from the intermediate image of the source Z or the center point of the first reflective optical element is less than approximately 100 mm away from the center point of the field facet mirror, so that angles of incidence of less than 6° are obtained.

In addition to an EUV illumination system with a beam path folded in accordance with the invention, the invention also provides a projection exposure system for EUV lithography with such a folded beam path as well as a method for producing microelectronic components.

It should be understood that various alternatives, combinations and modifications of the teachings described herein could be devised by those skilled in the art. The present invention is intended to embrace all such alternatives, modifications and variances that fall within the scope of the appended claims. It should also be understood that the disclosure content of this application comprises all possible combinations of any element(s) of any claims with any element(s) of any other claim, as well as combinations of all claims amongst each other.

1. An illumination system comprising:
a source of light having a wavelength of less than or equal to about 193 nm;
a first facet;
a second facet; and
a reflective element;
wherein said light is incident on said first facet via a first path, propagates from said first facet to said second facet via a second path, and propagates from said second facet to said reflective element via a third path, and
wherein said second path and said third path are in substantially opposite directions from one another and substantially parallel to each other.

2. The illumination system of claim 1, wherein said first path and said second path are in substantially opposite directions from one another and substantially parallel to each other.

3. The illumination system of claim 1, wherein said second and third paths have an angular deviation of less than about 12°.

4. The illumination system of claim 1,
wherein said first and second paths have an angular deviation of less than about 12°, and
wherein said second and third paths have an angular deviation of less than about 12°.

5-20. (canceled)
